(19) United States
(12) Patent Application Publication
(10) Pub. No.: US 2018/0271013 A1
(43) Pub. Date: Sep. 27, 2018

(54) Lightning Line

(71) Applicant: Michael Lee Mills, Mount Airy, NC (US)

(72) Inventor: Michael Lee Mills, Mount Airy, NC (US)

(21) Appl. No.: 15/468,834

(22) Filed: Mar. 24, 2017

(51) Int. Cl. A01D 34/416

(52) U.S. Cl. CPC A01D 34/4168; A01D 2101/00; A01D 34/4166

(57) ABSTRACT

The present invention is comprised of a fixed line for flexible line rotary trimmers in which one or more relatively short fixed lengths of cutting line are inserted into the original manufacturers equipment opposed orifices placed in the outer side wall of the trimmer line head housing and are secured in place by means of an encapsulated metal grommet The best use of current invention is to insert one end of fixed line into trimmer heads original equipment orifices and pull line until it is secured to the trimmer head by the grommet and rubberized encapsulation material. After use the worn or broken fixed trimmer line can be simply removed by grasping the encapsulated metal grommet and pulling the line from the trimmer head and new line can be reinstalled simply by repeating above installation steps.

### REFERENCES CITED [REFERENCED BY]

### U.S. Patent Documents

| | | |
|---|---|---|
| 3,708,967 | January 1973 | Geist et al. |
| 4,062,114 | December 1977 | Luick |
| 4,190,954 | March 1980 | Walto |
| 4,301,642 | November 1981 | Thurber |
| 4,411,069 | October 1983 | Close et al. |
| 4,453,486 | June 1984 | Harken |
| 4,644,655 | February 1987 | Bottamiller et al. |
| 4,685,759 | August 1987 | Kurtz |
| 4,756,146 | July 1988 | Rouse |
| 5,433,006 | July 1995 | Taguchi |
| 5,758,424 | June 1998 | Iacona et al. |
| 5,887,348 | March 1999 | Iacona et al. |
| 6,247,539 | June 2001 | Jerez |
| 6,249,978 | June 2001 | Sheldon |
| 6,347,455 | February 2002 | Brant et al. |
| 6,401,344 | June 2002 | Moore et al. |
| 6,519,857 | February 2003 | Proulx et al. |
| 2003/0033718 | February 2003 | Alliss |

### BACKGROUND INFORMATION

Weed and grass trimmers have been developed which employ a rotatable hub with a short length of flexible nylon or other plastic line extending from the hub. When the hub is rotated (typically at speeds from 6,000 RPM to 12,000 RPM), the tip of the line extending from the hub provides the cutting or trimming action. Grass and weed trimmers using this principle of operation have become popular for their versatility of use and because the flexible trim line is safer to use than rigid rotating steel blades.

Various types of devices have been developed for using such trim lines. Typically, rotating line trimmers or rotating string trimmers employ a line which generally has a circular cross section. The line, in many trimmers, is wound on a storage reel in the hub of the device and is fed out of a hole in the hub in discrete amounts, as the end breaks off or wears off. Trimmers of this type sometimes are referred to as “bump and feed” trimmers, since, when the line breaks off, the bottom of the storage reel is bumped on the ground to cause a spring release of the line within the trimmer; which then plays out a short length of line through a hole in the hub by means of centrifugal force when the trimmer is operating. Typically, the smaller (with 21/2″ diameter to 31/2″ diameter head) bump and feed string trimmers use relatively small diameter line, normally in the range of 0.065″ to 0.080″ diameter, since the smaller diameter flexible line functions better for the centrifugal feeding of such a smaller diameter bump and feed head.

The reason that small diameter line is used in “bump and feed” string trimmers is that heavier diameter line (for example, 0.115″ to 0.160″ diameter) typically is too stiff for winding and for the centrifugal feeding used in “bump and feed” heads. Commercial bump and feed heads use a larger diameter head than was designed for home use, and operate with somewhat larger diameter flexible line, generally from 0.95″ to 0.105″ diameter and normally have a larger capacity for such line. Thus, less frequent reloading of the line is required.

A problem exists with bump and feed trimmers, however, in that frequently the line which is wound on the storage reel in the hub tends to become stuck, either due to partial fusion of the line within the hub, caused by high frequency vibration, or by successive turns of the line wound on the hub becoming somewhat entangled. As a result, feeding of the line from the hub, when desired, does not always take place. When this occurs, it is necessary to remove the hub from the string trimmer device and manually extract the desired length of line prior to reattaching the hub to the device. This is a very time consuming and frustrating experience for many users of flexible line string trimmers.

For commercial use employing relatively large diameter lines, for example 0.115″ to 0.160″ diameter, fixed-line trimmer heads usually are employed. The large diameter monofilament nylon lines are particularly useful where weed and grass growth is dense. The large diameter lines also provide longer length of service before the line needs to be replaced. Due to the hole design and pattern, smaller standard sized lines (under about 0.095″ diameter) have a tendency to slip out of commercial fixed heads during operation.

One type of fixed line trimmer head for commercial use is the Echo®, heavy duty fixed line trimmer head, stock No. 999442-0020. This trimmer head is designed to replace a saw blade trimmer/brush cutter or other types of flexible line trimmer heads. The Echo®, trimmer head is open on its underside and provides serpentine paths for the insertion of two fixed lengths of 0.130″ diameter monofilament nylon line. The line is inserted between closely spaced, offset guide surfaces to hold it in place during operation. When a new length of line needs to be inserted, the old line must be removed, and the new line guided in place around the guide surfaces. Because the guide surfaces are close together and 0.130″ diameter line is relatively stiff, it is difficult to install and remove sections of nylon line from the Echo®, trimmer head. This difficulty results in excessive time being consumed for the removal and replacement of line segments.

Other approaches to providing trimmer heads using fixed lengths of line are disclosed in the United States patent to Luick U.S. Pat. No. 4,062,114; Jacyno U.S. Pat. No. 4,118,865; and Morabit U.S. Pat No. 6,314,848. All three of these patents disclose trimmer heads using lengths of line which have an enlarged portion, or an eyelet attached to one end for extension from the inside of the head out through an opening to be held in place by centrifugal force when the head is rotating. When the line is worn or breaks off, it may be removed from the inside by pulling back out in the opposite direction to allow replacement with a new line.

A problem which exists with this type of trimmer head and line combination, however, is that each length of line which is to be used with the head requires a special configuration on the inside end to prevent it from being pulled outwardly through the hole in the head from which the line extends. As a consequence, the cost of the line segments is substantially more than the cost for a line segment made of a piece of line which does not require the additional end configuration, or additional parts to be added to it.

Another issue exists with all of the above mentioned previous arts and many others sot listed above. In additional to cost issues with manufacture of the trimmer line itself there are also cost issues with them due to the fact that all require additional hardware and mechanisms to be manufactured in order to be able to be utilized in conjunction with any type of grass or weed trimmer machine.

Another issue with all other previous arts is they cannot be used in combination with all types, sizes, or manufacturer's brands of grass or weed trimmer machines without modification or addition of aftermarket hardware.

It would be desirable to produce a fixed cutting line for grass and weed trimmers that is cost effective, easily installed, durable, universal to all types of grass and weed trimmers, has no mechanical parts that could lead to failure, and would require no additional parts or hardware to be added to grass or weed trimmers that could possibly void manufacturers warranties.

Accordingly, it is an object of this invention to provide an improved fixed line for all types and manufacturers of string trimmer machines which overcomes the disadvantages of the prior art, which may be used as an alternative to bump and feed cartridges, which is simple to manufacture, which facilitates simple and quick loading and replacement of fixed lengths of trimmer line and can easily be used with any type and manufacturer of grass or weed trimmer machines.

### SUMMARY OF THE INVENTION

The present invention is comprised of a fixed line for flexible line rotary trimmers is which one or more relatively short fixed lengths of cutting line are inserted into the original manufacturers equipment opposed orifices placed in the outer side wail of the trimmer line head housing and are secured in place by means of an encapsulated metal grommet. The best use of current invention is to insert one end of fixed line into trimmer heads original equipment orifices and pull line until it is secured to the trimmer head by the grommet and rubberized encapsulation material. After use the worn or broken fixed trimmer line can be simply removed by grasping the encapsulated metal grommet and pulling the line from the trimmer head and new line can be reinstalled simply by repeating above installation steps

It is an object of the current invention to provide an improved fixed fine for grass and or weed trimmers

It is an object of the current invention to provide a fixed line that requires no mechanical components

It is an object of the current invention to provide a fixed line that is universal in that it can be used in combination with any type, size, or manufacturer's brand of grass or weed trimmer machine.

It is an object of the current invention to provide a fixed line that is universal in that it can be used in combination with any type, size, or manufacturer's brand of grass or weed trimmer machine without the addition of any type or apparatus of non original manufacturer's equipment being required See illustrations below

### DESCRIPTION OF DRAWINGS

FIG. 1 shows construction of the current invention

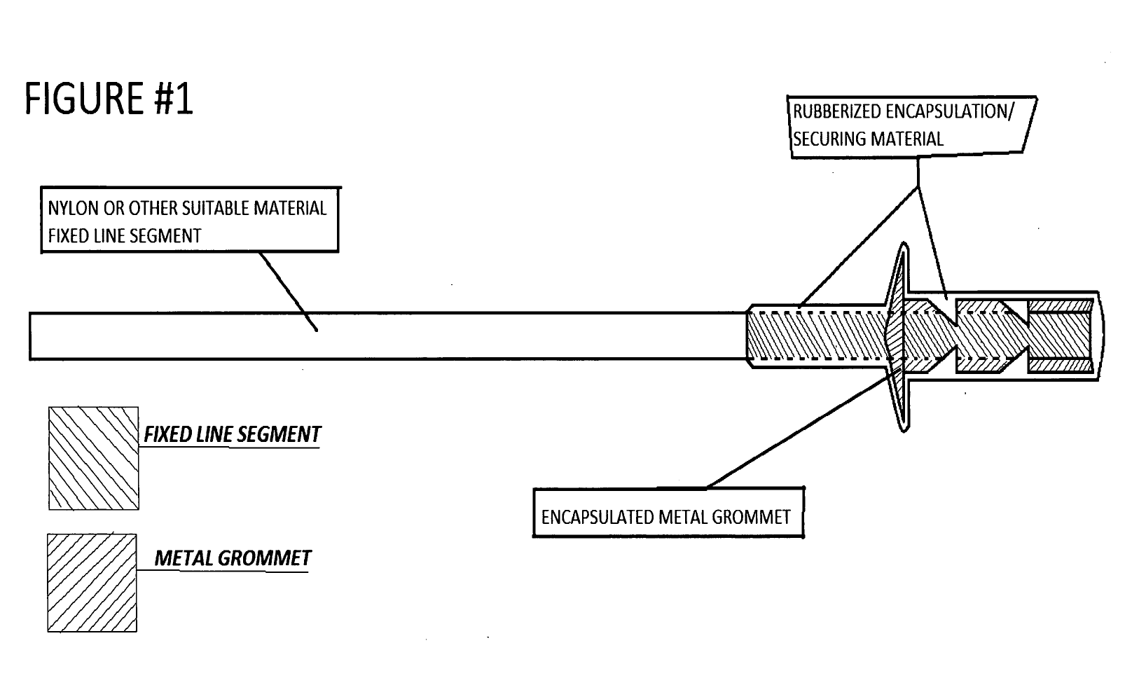

FIG. 2 shows current invention used in generic trimmer line machine head

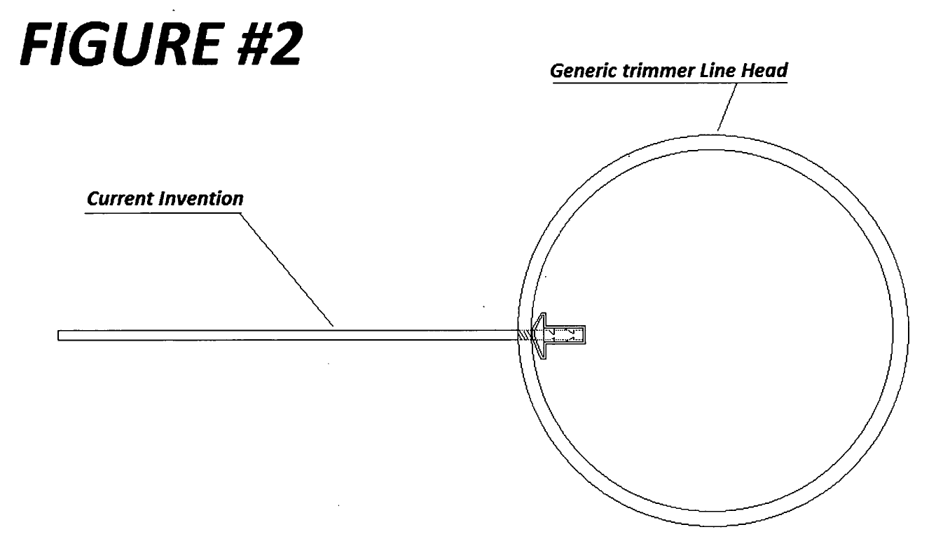

What is claimed is:

1-A fixed trimmer Line segment comprised of nylon or other suitable material

2-A metal grommet permanently attached to fixed line segment of claim 1

3-A rubberized material used to encapsulate metal grommet of claim 2
